(19) United States
(12) Patent Application Publication
(10) Pub. No.: US 2022/0171304 A1
(43) Pub. Date: Jun. 2, 2022

(54) TONER

(71) Applicant: SHARP KABUSHIKI KAISHA, Sakai City (JP)

(72) Inventors: Shinjiro HAYASHI, Sakai City (JP); YORITAKA TSUBAKI, Sakai City (JP)

(21) Appl. No.: 17/535,353

(22) Filed: Nov. 24, 2021

(30) Foreign Application Priority Data
Nov. 27, 2020 (JP) 2020-197175

(51) Int. Cl. G03G 9/097

(52) U.S. Cl. CPC G03G 9/09733

(57) ABSTRACT

A toner contains toner particles that include a binding resin, a crystalline resin, an ester wax and a dispersant. The binding resin includes an amorphous polyester resin, and the dispersant includes an acrylic copolymer resin or a hybrid resin of the amorphous polyester resin and a styrene resin. When an endothermic peak temperature that is derived from the ester wax in a temperature rise is represented by T1, an exothermic peak temperature that is derived from the ester wax in cooling is represented by T2, a peak temperature of the crystalline resin is represented by Tc and the endothermic peak temperature, the exothermic peak temperature and the peak temperature are measured with a differential scanning calorimeter, T2<Tc<T1 is satisfied, and T1 is greater than 65° C. and less than 85° C.

### CROSS-REFERENCE TO RELATED APPLICATION

The present application claims priority from Japanese Patent Application Number 2020-197175, the content to which is hereby incorporated by reference into this application.

### BACKGROUND OF THE INVENTION

### Field of the Invention

The present invention relates to toners.

### Description of the Background Art

In recent years, in toners (toners for electrophotography) used in image forming apparatuses such as a copying machine, a multifunctional machine, a printer and a facsimile machine that utilize an electrophotographic system, as energy used in the image forming apparatuses has been saved, low temperature fixation has been required.

When in order to achieve the low temperature fixation, a crystalline resin is added to a toner to reduce the viscosity of the toner at the time of fixation, offset on a high temperature side in a fixable region disadvantageously deteriorates. Hence, in general, in order to maintain the high temperature side in the fixable region, a wax is used as a mold release agent.

With respect to the low temperature fixing toner described above, Japanese Unexamined Patent Application Publication No. 2019-20690 discloses that in a toner which contains an amorphous polyester resin and a crystalline polyester resin and which contains a styrene-acrylic acid resin in the crystalline polyester resin, the dispersion diameter and the compatibility of the crystalline polyester resin are controlled to be able to enhance its low temperature fixation.

Japanese Unexamined Patent Application Publication No. 2018-84754 likewise discloses that in a toner which contains a styrene-acrylic acid resin in a crystalline polyester resin, the compatibility of an amorphous polyester resin, the crystalline polyester resin, the styrene-acrylic acid resin and an ester wax is appropriately adjusted and that thus the dispersibility of the ester wax is controlled to be able to secure heat resistance.

Japanese Unexamined Patent Application Publication No. 2017-116810 discloses that in a toner which contains an amorphous polyester resin, a crystalline polyester resin, a wax and a styrene-acrylic resin composition, a specific bulky and hydrophobic styrene-acrylic resin is mixed at a specific mass ratio and that thus a highly hydrophobic wax dispersant is exposed to the surface of the toner to be able to secure chargeability under high temperature and high humidity.

However, although an ester wax excellent in mold releasability is advantageous to the offset on the high temperature side in the fixable region, its dispersibility in the toner tends to be low, the ester wax is used together with the crystalline resin to further lower the dispersibility. If the dispersibility is low, when the toner is left to stand under a temperature condition of around 45° C., the wax bleeds on the surface of the toner to cause the agglomeration of the toner, with the result that the heat resistant storage property of the toner disadvantageously deteriorates. When in order to improve the dispersibility, shear strength is increased at the time of kneading of the toner, the crystalline resin and the polyester resin are compatible with each other, with the result that the glass transition temperature (Tg) of the toner is lowered to cause the heat resistant storage property to deteriorate. Hence, it is difficult to achieve, in the low temperature fixing toner, both offset resistance (hot offset resistance) on the high temperature side in the fixable region and the heat resistant storage property.

One aspect of the present invention is made in view of the circumstances described above, and an object thereof is to provide a toner that achieves both hot offset resistance and a heat resistant storage property by controlling the bleeding property of a wax in the toner.

### SUMMARY OF THE INVENTION

A toner according to one aspect of the present invention contains toner particles that include a binding resin, a crystalline resin, an ester wax and a dispersant. The binding resin includes an amorphous polyester resin, and the dispersant includes an acrylic copolymer resin or a hybrid resin of the amorphous polyester resin and a styrene resin. When an endothermic peak temperature that is derived from the ester wax in a temperature rise is represented by T1, an exothermic peak temperature that is derived from the ester wax in cooling is represented by T2, a peak temperature of the crystalline resin is represented by Tc and the endothermic peak temperature, the exothermic peak temperature and the peak temperature are measured with a differential scanning calorimeter (DSC), T2<Tc<T1 is satisfied, and T1 is greater than 65° C. and less than 85° C.

In one aspect of the present invention described above, the dispersant includes the acrylic copolymer resin or the hybrid resin of the amorphous polyester resin and the styrene resin, and thus the dispersant includes a copolymer containing an ingredient compatible with the polyester resin and an ingredient compatible with the ester wax, with the result that it is possible to optimize the dispersibility of the ester wax (in particular, a polyol ester wax) and the crystalline resin. Hence, at the time of storage under a high temperature condition of around 45° C., the bleeding of the ester wax and the plasticization of the toner caused by the crystalline resin are suppressed, and thus it is possible to improve the heat resistant storage property. At a fixing temperature, the ester wax is caused to bleed, and thus it is possible to sufficiently achieve an effect of the ester wax serving as a mold release agent, with the result that a fixable region can be extended to a high temperature side.

Furthermore, T2<Tc<T1 is satisfied, and thus the heat resistant storage property of the toner can be secured. The reason therefor is inferred as follows.

At the time of cooling after the kneading of the toner, the crystalline resin and the ester wax are crystallized in this order. Then, the crystalline resin acts as a crystal nucleating agent to facilitate the crystallization of the ester wax, and thus a highly crystalline wax domain is formed. When the toner serving as a product is stored under a high temperature environment, the crystalline resin and the ester wax are melted in this order. Hence, it is inferred that the ester wax is unlikely to be melted by the endothermic reaction of the crystalline resin, and that thus the bleeding is suppressed. The bleeding is suppressed, and thus the heat resistant storage property of the toner can be secured.

Since T1 is greater than 65° C. and less than 85° C., at the fixing temperature, both the crystalline resin and the ester wax are sufficiently melted so as not to prevent the bleeding of the ester wax, and thus the effect of the ester wax serving as the mold release agent is achieved, with the result that the hot offset resistance of the toner can be obtained. When T1 is equal to or less than 65° C., it is likely that it is difficult to secure the heat resistant storage property. When T1 is equal to or greater than 85° C., it is likely that the wax is not sufficiently melted at the fixing temperature. It is difficult to manufacture the ester wax in which T1 is higher than this temperature.

Preferably, in the toner described above, the ester wax includes a polyol ester wax, and the dispersion diameter of the ester wax in the toner particles is equal to or less than 1 μm.

As the ester wax, the polyol ester wax is used, and thus the hot offset resistance of the toner is more enhanced, with the result that the high temperature side in the fixable region can be extended. Since the polyol ester wax is unlikely to be dispersed, in order to control the bleeding, it is preferable to set the dispersion diameter equal to or less than 1 μm. If the dispersion diameter exceeds 1 μm, the bleeding occurs when the toner is stored under a high temperature environment, and thus it is likely that the heat resistant storage property cannot be secured.

Preferably, in the toner described above, when the SP value (solubility parameter) of the ester wax is represented by SP1, the SP value of the crystalline resin is represented by SP2 and the SP value of the amorphous polyester resin is represented by SP3, SP1<SP2<SP3 is satisfied, and SP2−SP1<1 is satisfied.

Since SP1<SP2<SP3 is satisfied and SP2−SP1<1 is satisfied, the SP value of the ester wax is close to the SP value of the crystalline resin and is separated from the SP value of the amorphous polyester resin, and thus the ester wax is compatible with the crystalline resin and is incompatible with the amorphous polyester resin. In this way, at the time of high temperature, the ester wax is easily left in the wax domain, and thus the bleeding is more suppressed, with the result that it is possible to realize the toner which is more excellent in the heat resistant storage property.

Preferably, in the toner described above, the endothermic peak temperature of the ester wax in the temperature rise is represented by T1, the glass transition temperature of the dispersant is represented by Ta and the endothermic peak temperature and the glass transition temperature are measured with the differential scanning calorimeter, Ta<T1 is satisfied.

The glass transition temperature of the dispersant is lower than the melting point (the endothermic peak temperature in the temperature rise) of the ester wax, and thus the low temperature fixation of the toner is prevented from being inhibited and the bleeding of the ester wax at the fixing temperature is prevented from being inhibited, with the result that the mold releasability of the ester wax can be sufficiently achieved.

Preferably, in the toner described above, the content of the ester wax in the toner particles is equal to or greater than 0.5% by mass and equal to or less than 5.0% by mass.

The content of the ester wax is set within the range described above, and thus the bleeding is prevented from occurring when the toner is stored under a high temperature environment (45° C.), and sufficient mold releasability is achieved in a state where the toner is melted when the toner is fixed, with the result that it is possible to achieve both the hot offset resistance and the heat resistant storage property.

Preferably, in the toner described above, the softening temperature (Tm) of the acrylic copolymer resin measured with a flow tester is equal to or greater than 95° C. and equal to or less than 119° C.

The softening temperature of the acrylic copolymer resin is equal to or less than 119° C., and thus the low temperature fixation of the toner can be more secured. It is inferred that since the viscosity of the acrylic copolymer resin in the molten state tends to be lowered, the ester wax is easily diffused in the toner in the molten state when the toner is fixed, and that thus the mold releasability of the ester wax is easily achieved. When the softening temperature of the acrylic copolymer resin is less than 95° C., the viscosity of the toner is lowered, and thus the offset resistance on the high temperature side in the fixable region may be adversely affected.

Preferably, in the toner described above, when the dispersant includes the acrylic copolymer resin, the content of the acrylic copolymer resin in the toner particles is equal to or greater than 1.0% by mass and equal to or less than 5.0% by mass. Preferably, when the dispersant includes the hybrid resin, the content of the hybrid resin in the toner particles is equal to or greater than 7.0% by mass and equal to or less than 32.0% by mass.

The content of the dispersant is set within the range described above, and thus it is possible to achieve both the dispersibility of the dispersant and the low temperature fixation of the toner. When the content of the dispersant is less than the lower limit described above, it is likely that the effect of the control of the dispersibility cannot be sufficiently obtained. When the content of the dispersant exceeds the upper limit described above, it is likely that bending strength on a low temperature side in the fixable region is reduced and that this contributes to the inhibition of the low temperature fixation.

According to one aspect of the present invention, it is possible to provide a toner that achieves both hot offset resistance and a heat resistant storage property by controlling the bleeding property of an ester wax in the toner.

### BRIEF DESCRIPTION OF THE DRAWINGS

FIG. 1 is a graph showing how to determine a glass transition temperature based on a DSC curve.

### DESCRIPTION OF THE PREFERRED EMBODIMENTS

Toner, Toner particles

The toner of one aspect of the present invention contains toner particles that include a binding resin, a crystalline resin, an ester wax and a dispersant. Furthermore, as necessary, any ingredient may be contained as long as the effects of one aspect of the present invention are not impaired. Although the volume average particle diameter of primary particles of the toner particles is not particularly limited, for example, toner particles in which the volume average particle diameter is equal to or greater than 4 μm and equal to or less than 8 μm are mentioned. The individual ingredients will be described below.

In one aspect of the present invention, the crystalline resin and an amorphous crystalline resin are distinguished by a crystallinity index, and a resin whose crystallinity index falls in a range equal to or greater than 0.6 and equal to or less than 1.5 is assumed to be the crystalline resin whereas a resin whose crystallinity index is less than 0.6 or greater than 1.5 is assumed to be the amorphous crystalline resin. The resin whose crystallinity index is greater than 1.5 is amorphous, and the resin whose crystallinity index is less than 0.6 is low in crystallinity and includes a large number of amorphous parts.

The crystallinity index is a physical property that serves as an index for the degree of crystallization of a resin, and is defined by a ratio (softening temperature/maximum endothermic peak temperature) of a softening temperature to the maximum endothermic peak temperature. Here, the maximum endothermic peak temperature indicates, among endothermic peaks that are observed, the peak temperature on the highest temperature side. In a crystalline polyester resin, the maximum peak temperature is assumed to be the melting point, and in an amorphous polyester resin, the peak on the highest temperature side is assumed to be a glass transition point.

The degree of crystallization can be controlled by adjusting the type and ratio of a raw material monomer, manufacturing conditions (for example, a reaction temperature, a reaction time and a cooling rate) and the like.

Binding Resin

The toner particles of one aspect of the present invention contain an amorphous polyester resin as the binding resin. As long as the effects of one aspect of the present invention are not impaired, an ingredient other than the amorphous polyester resin may be contained as the binding resin.

Amorphous Polyester Resin

The amorphous polyester resin used in the toner of one aspect of the present invention is an amorphous polyester resin obtained by performing polycondensation on a dicarboxylic acid monomer which includes terephthalic acid or isophthalic acid as the main ingredient and a diol monomer which includes ethylene glycol as the main ingredient.

The dicarboxylic acid monomer used in the synthesis of the amorphous polyester resin includes terephthalic acid or isophthalic acid as the main ingredient. Here, the molar content of terephthalic acid or isophthalic acid included in the dicarboxylic acid monomer is preferably equal to or greater than 70% and equal to or less than 100% and more preferably equal to or greater than 80% and equal to or less than 100%.

The dicarboxylic acid monomer described above can include an aromatic dicarboxylic acid or an aliphatic dicarboxylic acid other than terephthalic acid and isophthalic acid. Examples of the aromatic dicarboxylic acid other than terephthalic acid and isophthalic acid include fumaric acid and the like, and examples of the aliphatic dicarboxylic acid include adipic acid, sebacic acid, succinic acid and the like. The dicarboxylic acid monomer described above can also include an ester forming derivative of terephthalic acid or isophthalic acid, an ester forming derivative of the aromatic dicarboxylic acid other than terephthalic acid and isophthalic acid and an ester forming derivative of the aliphatic dicarboxylic acid. In one aspect of the present invention, as the ester forming derivative, an acid anhydride of a carboxylic acid, an alkyl ester or the like is included. When a dicarboxylic acid monomer other than terephthalic acid and isophthalic acid is used, one type of dicarboxylic acid monomer described above may be used singly or two or more types may be combined to be used.

In the synthesis of the amorphous polyester resin, together with the dicarboxylic acid monomer described above, a polycarboxylic acid monomer having a valency of three or more may be used. As the polycarboxylic acid monomer having a valency of three or more, a polycarboxylic acid having a valency of three or more such as trimellitic acid or pyromellitic acid or an ester forming derivative thereof can be used. When the polycarboxylic acid monomer having a valency of three or more is used, one type of polycarboxylic acid monomer described above may be used singly or two or more types may be combined to be used.

The diol monomer used in the synthesis of the amorphous polyester resin includes ethylene glycol as the main ingredient. Here, the molar content of ethylene glycol included in the diol monomer is preferably equal to or greater than 70% and equal to or less than 100% and more preferably equal to or greater than 80% and equal to or less than 100%.

The diol monomer described above can include 1,3-propylene glycol, 1,4-butanediol or the like. When a diol monomer other than ethylene glycol is used, one type of diol monomer described above may be used singly or two or more types may be combined to be used.

The amorphous polyester resin used in the toner of one aspect of the present invention can be manufactured in the same manner as a normal polyester manufacturing method. For example, a dicarboxylic acid monomer, a diol monomer and in some cases, a polycarboxylic acid monomer having a valency of three or more are used, a polycondensation reaction is performed in an atmosphere of nitrogen gas at a temperature of 190 to 240° C. and thus it is possible to synthesize the amorphous polyester resin.

In the polycondensation reaction described above, the reaction ratio of the diol monomer and a carboxylic acid monomer (including the dicarboxylic acid monomer and in some cases, the polycarboxylic acid monomer having a valency of three or more) is preferably 1.3:1 to 1:1.2 as the equivalent ratio [OH]:[COOH] of a hydroxy group to a carboxyl group. In the polycondensation reaction described above, the molar content of the dicarboxylic acid monomer included in the carboxylic acid monomer is preferably 80 to 100%. Furthermore, in the polycondensation reaction described above, as necessary, an esterification catalyst such as dibutyltin oxide or titanium alkoxide (for example, tetrabutoxytitanate) can be used.

The glass transition temperature (Tg) of the amorphous polyester resin described above is preferably 50 to 70° C. in terms of fixation, a storage property, durability and the like. On the other hand, when the glass transition temperature falls outside this range, the balance of the fixation, the storage property and the durability may be lost.

The softening temperature (Tm) of the amorphous polyester resin described above is preferably 100 to 150° C. in order to achieve both low temperature fixation and hot offset resistance. On the other hand, when the softening temperature falls outside this range, the balance of the low temperature fixation and the hot offset resistance may be lost.

With respect to the molecular weight of the amorphous polyester resin described above, a peak top molecular weight (Mp) of part soluble in tetrahydrofuran (THF) that is measured by gel permeation chromatography (GPC) is preferably 3000 to 10500 in order to achieve all of the heat resistance, the heat storage property and the low temperature fixation of the toner. On the other hand, when the peak top molecular weight falls outside the range of 3000 to 10500, the balance of the heat resistance, the heat storage property and the low temperature fixation of the toner may be lost.

In the GPC, tetrahydrofuran (THF) is used as a mobile phase, and polystyrene is used as the standard material. The peak top molecular weight refers to a molecular weight that indicates the maximum peak height in a chromatogram obtained by the measurement of the GPC.

The acid value of the amorphous polyester resin described above is preferably 0 to 60 mg KOH/g in terms of a charging property, and the hydroxyl value of the amorphous polyester resin described above is 0 to 50 mg KOH/g in terms of the hot offset resistance. On the other hand, when the acid value is greater than 60 mg KOH/g, the charging performance may be degraded whereas when the hydroxyl value is greater than 50 mg KOH/g, the hot offset resistance may be insufficient.

The SP value (solubility parameter) of the amorphous polyester resin is preferably 10.5 to 12.5.

Although in the toner of one aspect of the present invention, the content of the amorphous polyester resin is not particularly limited, the content is preferably 50 to 80% by mass in the toner particles.

Crystalline Resin

In the toner of one aspect of the present invention, the crystalline resin is dispersed in the amorphous polyester resin. The crystalline resin used in the toner of one aspect of the present invention preferably includes the crystalline polyester resin. The crystalline polyester resin is a crystalline polyester resin that is formed with linear saturated aliphatic polyester units obtained by performing polycondensation on a dicarboxylic acid monomer which includes an aliphatic dicarboxylic acid having 9 to 22 carbon atoms as the main ingredient and a diol monomer which includes an aliphatic diol having 2 to 10 carbon atoms as the main ingredient. The crystalline polyester resin is formed with the linear saturated aliphatic polyester units, and thus this crystalline polyester resin and the amorphous polyester resin are unlikely to be compatible with each other.

The dicarboxylic acid monomer used in the synthesis of the crystalline polyester resin includes the aliphatic dicarboxylic acid having 9 to 22 carbon atoms as the main ingredient. Here, the molar content of the aliphatic dicarboxylic acid having 9 to 22 carbon atoms included in the dicarboxylic acid monomer is preferably equal to or greater than 80% and equal to or less than 100%.

Examples of the aliphatic dicarboxylic acid having 9 to 22 carbon atoms described above include azelaic acid, sebacic acid, 1,10-decanedicarboxylic acid, 1,18-octadecanedicarboxylic acid and the like. The dicarboxylic acid monomer can include ester forming derivatives of these aliphatic dicarboxylic acids. One type of dicarboxylic acid monomer described above may be used singly or two or more types may be combined to be used.

In the synthesis of the crystalline polyester resin, together with the dicarboxylic acid monomer described above, a polycarboxylic acid monomer having a valency of three or more may be used. As the polycarboxylic acid monomer having a valency of three or more, a polycarboxylic acid having a valency of three or more such as trimellitic acid or pyromellitic acid or an ester forming derivative thereof can be used. When the polycarboxylic acid monomer having a valency of three or more is used, one type of polycarboxylic acid monomer described above may be used singly or two or more types may be combined to be used.

The diol monomer used in the synthesis of the crystalline polyester resin includes the aliphatic diol having 2 to 10 carbon atoms as the main ingredient. Here, the molar content of the aliphatic diol having 2 to 10 carbon atoms included in the diol monomer is preferably equal to or greater than 80% and equal to or less than 100%.

Examples of the aliphatic diol having 2 to 10 carbon atoms include ethylene glycol, 1,4-butanediol, 1,6-hexanediol and the like. One type of diol monomer described above may be used singly or two or more types may be combined to be used.

In the synthesis of the crystalline polyester resin, together with the diol monomer described above, a polyol monomer having a valency of three or more may be used. As the polyol monomer having a valency of three or more, glycerin, trimethylolpropane or the like can be used. When the polyol monomer having a valency of three or more is used, one type of polyol monomer described above may be used singly or two or more types may be combined to be used.

The crystalline polyester resin used in the toner of one aspect of the present invention can be manufactured in the same manner as the normal polyester manufacturing method. For example, a dicarboxylic acid monomer, a diol monomer, in some cases, a polycarboxylic acid monomer having a valency of three or more and a polyol monomer having a valency of three or more are used, a polycondensation reaction is performed in an atmosphere of nitrogen gas at a temperature of 190 to 240° C. and thus it is possible to synthesize the crystalline polyester resin.

In the polycondensation reaction described above, the equivalent ratio (OH group/COOH group) of the hydroxy group of the polyol monomer (including the diol monomer and in some cases, the polyol monomer having a valency of three or more) to the carboxyl group of the carboxylic acid monomer (including the dicarboxylic acid monomer and in some cases, the polycarboxylic acid monomer having a valency of three or more) is preferably 0.83 to 1.3 in terms of the storage property and the like. In the polycondensation reaction described above, the molar content of the dicarboxylic acid monomer included in the carboxylic acid monomer is preferably 90 to 100%. As the molar content of the dicarboxylic acid monomer described above is lower, the ratio and rate of crystallization are lowered, with the result that toner agglomeration resistance is insufficient. Furthermore, in the polycondensation reaction described above, the molar content of the diol monomer included in the polyol monomer is preferably 80 to 100%. In the polycondensation reaction described above, as necessary, an esterification catalyst such as dibutyltin oxide or titanium alkoxide (for example, tetrabutoxytitanate) can be used.

The melting point (Tmp) of the crystalline polyester resin described above is preferably equal to or greater than 40° C. and is more preferably 60 to 90° C. in terms of the fixation, the storage property, the durability and the like. When the melting point is less than 40° C., the durability may be insufficient. When the melting point is equal to or greater than 90° C., the fixation may be insufficient.

The softening temperature (Tm) of the crystalline polyester resin described above is preferably 65 to 110° C. in terms of the low temperature fixation and blocking resistance. On the other hand, when the softening temperature falls outside this range, the low temperature fixation and the blocking resistance are insufficient.

In the crystalline polyester resin described above, in terms of a crystallization rate and the blocking resistance, a ratio (Tm/Tmp) of the softening temperature (Tm) to the melting point (Tmp) is preferably 1.0 to 1.4. On the other hand, the ratio of the softening temperature to the melting point falls outside this range, the crystallization rate and the blocking resistance may be insufficient.

With respect to the molecular weight of the crystalline polyester resin described above, the peak top molecular weight (Mp) of part soluble in tetrahydrofuran (THF) that is measured by gel permeation chromatography (GPC) is preferably 10000 to 90000 in terms of the storage property, the low temperature fixation and the like. In the GPC, tetrahydrofuran (THF) is used as the mobile phase, and polystyrene is used as the standard material. The peak top molecular weight refers to a molecular weight that indicates the maximum peak height in a chromatogram obtained by the measurement of the GPC. On the other hand, when the peak top molecular weight falls outside the range described above, the storage property and the low temperature fixation may be insufficient.

The acid value of the crystalline polyester resin described above is preferably 0 to 60 mg KOH/g in terms of the charging property, and the hydroxyl value of the crystalline polyester resin described above is 0 to 40 mg KOH/g in terms of the hot offset resistance. On the other hand, when the acid value is greater than 60 mg KOH/g, the charging performance may be degraded whereas when the hydroxyl value is greater than 40 mg KOH/g, the hot offset resistance may be insufficient.

The SP value (solubility parameter) of the crystalline polyester resin described above is preferably 9.3 to 10.0. When the SP value is less than 9.3, it is likely that compatibility with the amorphous polyester resin is excessively lowered and that thus the durability is insufficient. On the other hand, when the SP value exceeds 10.0, it is likely that the glass transition temperature (Tg) of the binding resin is lowered and that thus the blocking resistance is lowered.

Although in the toner of one aspect of the present invention, the content of the crystalline polyester resin is not particularly limited, the content is preferably 3 to 30% by mass in the toner particles.

Ester Wax

The toner particles of one aspect of the present invention include the ester wax as the mold release agent. The ester wax serving as the mold release agent is added to provide mold releasability to the toner when the toner is fixed to a recording medium. In the toner of one aspect of the present invention, the mold release agent is dispersed in the amorphous polyester resin.

As the ester wax serving as the mold release agent in one aspect of the present invention, for example, a synthetic ester wax can be used. Examples of the synthetic ester wax include Nissan Electorl Waxes (made by NOF CORPORATION, WEP-2, WEP-3, WEP-4, WEP-5, WEP-6, WEP-7, WEP-8, WEP-9 and WEP-10) and the like.

Examples of a monoester wax among synthetic ester waxes include WE-11, WE-12. WE-13, Unistar M-B96R (all of which are product names, made by NOF CORPORATION) and the like, and examples of a polyol ester wax include WEP-8, WE-14, WE-15 (product names, made by NOF CORPORATION) and the like.

In the toner of one aspect of the present invention, when an endothermic peak temperature that is derived from the ester wax in a temperature rise is represented by T1, an exothermic peak temperature that is derived from the ester wax in cooling is represented by T2, a peak temperature of the crystalline resin is represented by Tc and the endothermic peak temperature, the exothermic peak temperature and the peak temperature are measured with a differential scanning calorimeter, T2<Tc<T1 is satisfied, and T1 is greater than 65° C. and less than 85° C. A more preferred range of T1 is equal to or greater than 70° C. and equal to or less than 80° C.

T2<Tc<T1 is satisfied, and thus the heat resistant storage property of the toner can be secured. The reason therefor is inferred as follows.

At the time of cooling after the kneading of the toner, the crystalline resin and the ester wax are crystallized in this order. Then, the crystalline resin acts as a crystal nucleating agent to facilitate the crystallization of the ester wax, and thus a highly crystalline wax domain is formed. When the toner serving as a product is stored under a high temperature environment, the crystalline resin and the ester wax are melted in this order. Hence, it is inferred that the ester wax is unlikely to be melted by the endothermic reaction of the crystalline resin, and that thus the bleeding is suppressed. The bleeding is suppressed, and thus the heat resistant storage property of the toner can be secured.

Since T1 falls within the range described above, at the fixing temperature, both the crystalline resin and the ester wax are sufficiently melted so as not to prevent the bleeding of the ester wax, and thus the effect of the ester wax serving as the mold release agent is achieved, with the result that the hot offset resistance of the toner can be obtained. When T1 is less than the lower limit described above, it is likely that it is difficult to secure the heat resistant storage property. When T1 exceeds the upper limit described above, it is likely that the wax is not sufficiently melted at the fixing temperature. It is difficult to manufacture the ester wax in which T1 is higher than this temperature.

The dispersion diameter of the ester wax in the toner particles of one aspect of the present invention is preferably equal to or less than 1 μm and more preferably equal to or less than 0.7 μm. The dispersion diameter described above is further preferably equal to or less than 0.2 μm. In the toner of one aspect of the present invention, the ester wax preferably includes the polyol ester wax. As the ester wax, the polyol ester wax is used, and thus the hot offset resistance of the toner is more enhanced, with the result that the high temperature side in the fixable region can be extended. Since the polyol ester wax is unlikely to be dispersed, in order to control the bleeding, it is preferable to set the dispersion diameter equal to or less than the upper limit described above. If the dispersion diameter exceeds the upper limit described above, the bleeding occurs when the toner is stored under a high temperature environment, and thus it is likely that the heat resistant storage property cannot be secured.

Preferably, in the toner of one aspect of the present invention, when the SP value (solubility parameter) of the ester wax is represented by SP1, the SP value of the crystalline resin is represented by SP2 and the SP value of the amorphous polyester resin is represented by SP3, SP1<SP2<SP3 is satisfied, and SP2−SP1≤1 is satisfied.

Since SP1<SP2<SP3 is satisfied and SP2−SP1≤1 is satisfied, the SP value of the ester wax is close to the SP value of the crystalline resin and is separated from the SP value of the amorphous polyester resin, and thus the ester wax is compatible with the crystalline resin and is incompatible with the amorphous polyester resin. In this way, at the time of high temperature, the ester wax is easily left in the wax domain, and thus the bleeding is more suppressed, with the result that it is possible to realize the toner which is more excellent in the heat resistant storage property.

The content of the ester wax in the toner particles of one aspect of the present invention is preferably equal to or greater than 0.5% by mass and equal to or less than 5.0% by mass and more preferably equal to or greater than 2.5% by mass and equal to or less than 4.5% by mass. The content of the ester wax is set within the range described above, and thus the bleeding is prevented from occurring when the toner is stored under a high temperature environment (45° C.), and sufficient mold releasability is achieved in a state where the toner is melted when the toner is fixed, with the result that it is possible to achieve both the hot offset resistance and the heat resistant storage property.

Dispersant

The toner particles of one aspect of the present invention include, as the dispersant, the acrylic copolymer resin or the hybrid resin of the amorphous polyester resin and a styrene resin. In this way, the dispersant includes a copolymer containing an ingredient compatible with the polyester resin and an ingredient compatible with the ester wax, with the result that it is possible to optimize the dispersibility of the ester wax (in particular, the polyol ester wax) and the crystalline resin. Hence, at the time of storage under a high temperature condition of around 45° C., the bleeding of the ester wax and the plasticization of the toner caused by the crystalline resin are suppressed, and thus it is possible to improve the heat resistant storage property. At a fixing temperature, the ester wax is caused to bleed, and thus it is possible to sufficiently achieve an effect of the ester wax serving as a mold release agent, with the result that a fixable region can be extended to a high temperature side.

Although as the acrylic copolymer resin, for example, a styrene-acrylic acid ester copolymer resin or the like can be used, the acrylic copolymer resin is preferably a resin obtained by copolymerizing a raw material monomer including styrene and n-butyl acrylate. Preferably, the acrylic copolymer resin is not denatured by being grafted with an aliphatic hydrocarbon resin.

As the hybrid resin of the amorphous polyester resin and the styrene resin, either a block copolymer or a graft copolymer can be used, and for example, the hybrid resin can be manufactured by cross-linking the amorphous polyester resin and the styrene resin described above with a known method.

Preferably, in the toner of one aspect of the present invention, when the endothermic peak temperature of the ester wax in the temperature rise is represented by T1, the glass transition temperature of the dispersant is represented by Ta and the endothermic peak temperature and the glass transition temperature are measured with the differential scanning calorimeter, Ta<T1 is satisfied.

The glass transition temperature of the dispersant is lower than the melting point (the endothermic peak temperature in the temperature rise) of the ester wax, and thus the low temperature fixation of the toner is prevented from being inhibited and the bleeding of the ester wax at the fixing temperature is prevented from being inhibited, with the result that the mold releasability of the ester wax can be sufficiently achieved.

The glass transition temperature (Ta) of the dispersant is preferably equal to or greater than 50° C. and equal to or less than 70° C. The glass transition temperature falls within the range described above, and thus it is possible to achieve both the low temperature fixation and the heat resistant storage property. When Ta is less than 50° C., the heat resistant storage property may deteriorate. When Ta exceeds 70° C., the low temperature fixation may be inhibited.

Preferably, in the toner described above, the softening temperature (Tm) of the acrylic copolymer resin measured with a flow tester is equal to or greater than 95° C. and equal to or less than 119° C.

The softening temperature of the acrylic copolymer resin is equal to or less than 119° C., and thus the low temperature fixation of the toner can be more secured. It is inferred that since the viscosity of the acrylic copolymer resin in the molten state tends to be lowered, the ester wax is easily diffused in the toner in the molten state when the toner is fixed, and that thus the mold releasability of the ester wax is easily achieved. When the softening temperature of the acrylic copolymer resin is less than 95° C., the viscosity of the toner is lowered, and thus the offset resistance on the high temperature side in the fixable region may be adversely affected.

Preferably, when the dispersant includes the acrylic copolymer resin, the content of the acrylic copolymer resin in the toner particles of one aspect of the present invention is equal to or greater than 1.0% by mass and equal to or less than 5.0% by mass. Preferably, when the dispersant includes the hybrid resin of the amorphous polyester resin and the styrene resin, the content of the hybrid resin in the toner particles of one aspect of the present invention is equal to or greater than 7.0% by mass and equal to or less than 32.0% by mass.

The content of the dispersant is set within the range described above, and thus it is possible to achieve both the dispersibility of the dispersant and the low temperature fixation of the toner. When the content of the dispersant is less than the lower limit described above, it is likely that the effect of the control of the dispersibility cannot be sufficiently obtained. When the content of the dispersant exceeds the upper limit described above, it is likely that bending strength on a low temperature side in the fixable region is reduced and that this contributes to the inhibition of the low temperature fixation.

Other Internal Additives

The toner particles of one aspect of the present invention may contain, as necessary, internal additives other than those described above. Examples of the internal additive other than those described above include a colorant and a charge control agent. The colorant and the charge control agent are dispersed in the binding resin.

The colorant is not particularly limited, and an organic dye, an organic pigment, an inorganic dye, an inorganic pigment and the like that are used in an electrophotographic field can be used.

As a black colorant, for example, carbon black, copper oxide, manganese dioxide, aniline black, activated carbon, non-magnetic ferrite, magnetic ferrite and magnetite can be used.

As a yellow colorant, for example, C. I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 138, C.I. Pigment Yellow 180 and C.I. Pigment Yellow 185 can be used.

As a magenta colorant, for example, C. I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178 and C.I. Pigment Red 222 can be used.

As a cyan colorant, for example, C. I. Pigment Blue 15, C.I. Pigment Blue 15:2, C.I. Pigment Blue 15:3, C.I. Pigment Blue 16, C.I. Pigment Blue 60 and the like can be used.

Although in the toner of one aspect of the present invention, the content of the colorant is not particularly limited, the content is preferably equal to or greater than 4% by mass and equal to or less than 10% by mass in the toner particles. One type of colorant may be used singly or two or more types may be used together. The colorant may be formed into masterbatches to be used so that the colorant is uniformly dispersed in the binding resin.

The charge control agent is added to provide chargeability suitable for the toner. The charge control agent is not particularly limited, and charge control agents for positive charge control and negative charge control that are used in the electrophotographic field can be used.

As the charge control agent for positive charge control, for example, a quaternary ammonium salt, a pyrimidine compound, a triphenylmethane derivative, a guanidine salt and an amidine salt can be used.

As the charge control agent for negative charge control, for example, a metal-containing azo compound, an azo complex dye, salicylic acid, metal complexes and metal salts (metals are chromium, zinc, zirconium and the like) of their derivatives, an organic bentonite compound and a boron compound can be used.

External Additive

An external additive may be added to the toner of one aspect of the present invention as necessary. The external additive is adhered to the surfaces of the toner particles. In the following description, as necessary, among the toners of one aspect of the present invention, the toner including the toner particles in which the external additive is adhered to the surfaces is referred to as an external additive toner.

The external additive is not particularly limited, and external additives used in the electrophotographic field can be used. Although in the toner of one aspect of the present invention, the content of the external additive is not particularly limited, the content is preferably equal to or greater than 0.5 parts by mass and equal to or less than 4 parts by mass with respect to 100 parts by mass of the toner particles. One type of external additive may be used singly or two or more types may be used together.

### EXAMPLES

Although one aspect of the present invention will be described below based on examples and comparative examples, the present invention is not limited to these examples.

Production of Toner Particles

### Example 1

Material Mixing ⋅ Kneading ⋅ Crushing ⋅ Classification Steps After the following ingredients were premixed with a Henschel mixer for 5 minutes, they were melted and kneaded with a biaxial extruder under conditions of a cylinder setting temperature of 110° C., a barrel rotation speed of 300 rpm and a raw material supply speed of 20 kg/time, and then a molten/kneaded product was obtained.
Binding resin: amorphous polyester resin P 79% by mass
Crystalline polyester resin A 7% by mass
Colorant: carbon black (made by Cabot Corporation, product name: Regal 330) 6% by mass⋅ Mold release agent: monoester wax (1) 4% by mass
Dispersant: acrylic copolymer resin X 4% by mass

After the molten/kneaded product which was obtained was cooled with a colling belt, the product was coarsely crushed with a cutting mill, was then finely crushed with a jet-type crusher and was further classified with a wind power classifier, with the result that toner particles (toner matrix particles) having an average particle diameter of 6.7 μm were obtained.

External Additive Step

1.0 part by mass of commercially available silica fine particles (product name: R976, made by AEROSIL CO., LTD., average primary particle diameter of 7 nm) was added to 100 parts by mass of the toner particles (toner matrix particles) obtained in the steps described above, and the resulting mixture was stirred for 2 minutes with an airflow mixer (made by Mitsui Mining Co., Ltd., a Henschel mixer) in which the tip speed of a stirring blade was set to 40 m/second, with the result that an external additive toner was obtained.

### Examples 2 to 22, Comparative Examples 1 to 7

A list of crystalline polyester resins used in the examples and the comparative examples is shown in table 1 below, a list of amorphous polyester resins used in the examples and the comparative examples is shown in table 2 below, a list of ester waxes used in the examples and the comparative examples is shown in table 3 below and a list of dispersants used in the examples and the comparative examples is shown in table 4 below. These materials were added in the same manner as in example 1 except that the materials were added by combinations shown in table 5, and thus external additive toners were obtained. In tables 4 and 5, “acryl” in the dispersant indicates the acrylic copolymer resin, and “hybrid” indicates the hybrid resin of the amorphous polyester resin and the styrene resin.

TABLE 1

| Type of C-Pes | Tc (° C.) | SP2 |
|---|---|---|
| A | 72 | 9.6 |
| B | 65 | 9.8 |
| C | 60 | 9.5 |
| D | 67 | 10.0 |

*C-Pes: Crystalline polyester resin

TABLE 2

| Type of Pes | SP3 |
|---|---|
| P | 10.9 |
| Q | 11.3 |

*Pes: Amorphous polyester resin

TABLE 3

| Type of wax | Product name | Maker | T1 (° C.) | T2 (° C.) | SP1 |
|---|---|---|---|---|---|
| Monoester (1) | Unistar M-B96R | NOF | 75 | 64 | 8.9 |
| Monoester (2) | WE-12 | NOF | 72 | 62 | 8.9 |
| Monoester (3) | WE-11 | NOF | 65 | 61 | 8.6 |
| Monoester (4) | WEP-5 | NOF | 85 | 65 | 8.6 |
| Polyol (1) | WE-15 | NOF | 79 | 62 | 8.9 |
| Polyol (2) | WE-14 | NOF | 80 | 65 | 8.6 |

TABLE 4

| Type of dispersant | Tc (° C.) | Tm (° C.) |
|---|---|---|
| X (acryl) | 56 | 97 |
| Y (acryl) | 68 | 118 |
| Z (hybrid) | 58 | 142 |

TABLE 5

| | | | | | Added amount | |
|---|---|---|---|---|---|---|
| | C- | | | | (mass %) | |
| | Pes | Pes | Wax | Dispersant | Wax | Dispersant |
| Example 1 | A | P | Monoester (1) | X (acryl) | 4 | 4 |
| Example 2 | B | Q | Monoester (2) | X (acryl) | 4 | 4 |
| Example 3 | A | P | Polyol (2) | X (acryl) | 4 | 4 |
| Example 4 | A | P | Polyol (1) | X (acryl) | 4 | 4 |
| Example 5 | A | P | Polyol (1) | X (acryl) | 4 | 1 |
| Example 6 | B | Q | Monoester (1) | X (acryl) | 4 | 4 |
| Example 7 | D | P | Monoester (2) | X (acryl) | 4 | 4 |
| Example 8 | B | Q | Monoester (2) | X (acryl) | 4 | 4 |
| Example 9 | A | P | Monoester (1) | X (acryl) | 4 | 4 |
| Example 10 | A | P | Monoester (1) | X (acryl) | 6 | 4 |
| Example 11 | A | P | Monoester (1) | X (acryl) | 5 | 4 |
| Example 12 | A | P | Monoester (1) | X (acryl) | 0.5 | 4 |
| Example 13 | A | P | Monoester (1) | X (acryl) | 4 | 6 |
| Example 14 | A | P | Monoester (1) | X (acryl) | 4 | 5 |
| Example 15 | A | P | Monoester (1) | X (acryl) | 4 | 1 |
| Example 16 | A | P | Monoester (1) | X (acryl) | 4 | 0.5 |
| Example 17 | A | P | Monoester (1) | Z (hybrid) | 4 | 35.0 |
| Example 18 | A | P | Monoester (1) | Z (hybrid) | 4 | 30.0 |
| Example 19 | A | P | Monoester (1) | Z (hybrid) | 4 | 22.4 |
| Example 20 | A | P | Monoester (1) | Z (hybrid) | 4 | 7.0 |
| Example 21 | A | P | Monoester (1) | Z (hybrid) | 4 | 5.0 |
| Example 22 | A | P | Polyol (1) | X (acryl) | 4.5 | 1 |
| Comparative | A | P | Monoester (3) | X (acryl) | 4 | 4 |
| example 1 | | | | | | |
| Comparative | C | P | Polyol (1) | X (acryl) | 4 | 4 |
| example 2 | | | | | | |
| Comparative | A | P | Monoester (1) | | 4 | |
| example 3 | | | | | | |
| Comparative | B | P | Monoester (3) | X (acryl) | 4 | 4 |
| example 4 | | | | | | |
| Comparative | B | P | Monoester (3) | Y (acryl) | 4 | 4 |
| example 5 | | | | | | |
| Comparative | A | P | Monoester (4) | X (acryl) | 4 | 4 |
| example 6 | | | | | | |
| Comparative | A | P | | X (acryl) | 0 | 4 |
| example 7 | | | | | | |

Evaluations

Various types of measurements were performed on the toners of the examples and the comparative examples according to the following methods, and thus the low temperature fixation, the high temperature fixation and the heat resistant storage property of the toners were evaluated. The results of these evaluation are shown in table 6 below.

Method for Measuring Various Types of Peak Temperatures by DSC Measurement

A differential scanning calorimeter (product name: DSC220, made by Seiko Instruments Inc.) was used, 1 g of a sample was heated up to 150° C. at a temperature rise rate of 10° C. per minute, was then held at 150° C. for 2 minutes and was cooled down to 30° C. at a cooling rate of 10° C. per minute and then a DSC curve was measured. From the obtained DSC curve, an endothermic peak temperature (T1) that was derived from the ester wax in the temperature rise, an exothermic peak temperature (T2) that was derived from the ester wax in the cooling and a peak temperature (Tc) of the crystalline resin were determined.

Method for Measuring Glass Transition Temperature by DSC Measurement

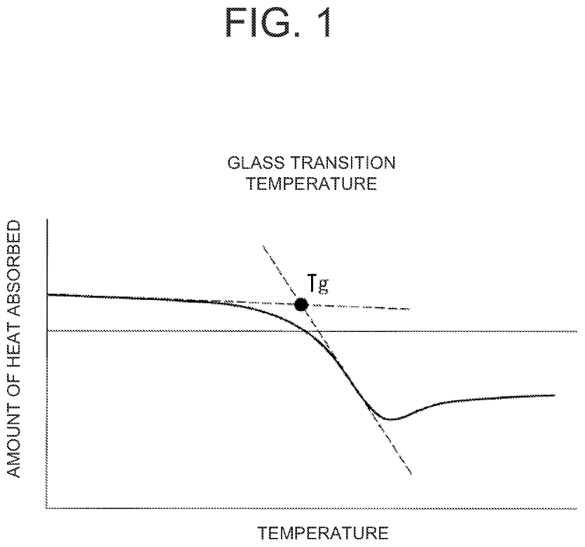

According to Japanese Industrial Standards (JIS) K7121-1987, the differential scanning calorimeter (product name: DSC220, made by Seiko Instruments Inc.) was used, 1 g of a sample was heated at a temperature rise rate of 10° C. per minute and then a DSC curve was measured. As shown in FIG. 1, a temperature at an intersection of a straight line obtained by extending, to the low temperature side, a base line on the high temperature side of an endothermic peak corresponding to the glass transition of the obtained DSC curve and a tangent line drawn at such a point that the gradient of a curve from part where the peak rose to a vertex was maximized was determined as the glass transition temperature (Tg).

Method for Measuring Outflow Start Temperature “Ti” and Softening Temperature “Tm” by Flow Tester Measurement

A flow characteristic evaluation device (manufactured by Shimadzu Corporation, flow tester, model number: CFT-100C) was used, a load of 20 kgf/cm2 (9.8×105 Pa) was applied while 1 g of a sample was being heated from a starting temperature of 40° C. at a temperature rise rate of 6° C. per minute, and thus the sample was caused to flow out from a die (having a nozzle caliber of 1 mm and a length of 1 mm). A temperature at which the sample started to flow out was assumed to be an outflow start temperature “Ti”, and a temperature at which a half of the sample flowed out was assumed to be a softening temperature “Tm”.

Method for Measuring Dispersion Diameter of Ester Wax

The toner was embedded in an epoxy resin, a surface was made to appear with an ultra microtome (made by Reichert, Inc., product name: Ultra Cut N) and thus a sample was obtained. For the obtained sample, the state of dispersion of the mold release agent (wax) was observed with a scanning transmission electron microscope (made by Hitachi High-Tech Corporation., model: S-4800). From electron micrograph data that was obtained, 200 to 300 wax portions were randomly extracted, image analysis was performed with image analysis software (product name: “A image-kun”, made by Asahi Kasei Engineering Corporation.) and thus a circle equivalent diameter (μm) of the wax was determined, with the result that this was assumed to be the dispersion diameter (μm) of the wax.

Method for Calculating SP Value

An SP value was calculated by a method that was described in “POLYMER ENGINEERING AND SCIENCE, FEBRUARY, 1974, Vol. 14, No. 2, ROBERT F.FEDORS. (pages 147-154)” proposed by Fedors et al.

Method for Evaluating Fixation

A commercially available copying machine (made by Sharp Corporation, model: MX-5100FN) that was modified for evaluations was used to form a fixed image using a two-component developer. First, on a recording sheet (made by Sharp Corporation, PPC paper, model: SF-4AM3), a sample image including a solid image (rectangular with a length of 20 mm and a width of 50 mm) was formed as an unfixed image. Here, the amount of toner adhered to the solid image on the recording sheet was adjusted to be 1.0 mg/cm².

Then, a belt fixing device was used to produce the fixed image. A fixing process rate was set to 283 mm/second, the temperature of a fixing belt was increased in increments of 5° C. from 110° C. and thus the minimum temperature and the maximum temperature were determined so as to prevent the occurrence of low temperature offset and high temperature offset.

The “low temperature offset” and the “high temperature offset” were defined as a phenomenon in which the toner was not fixed to the recording sheet at the time of fixation and in which the fixing belt was turned one revolution with the toner adhered to the fixing belt and was thereafter adhered to the recording sheet.

From the results that were obtained, the “low temperature fixation” was determined by the following criteria.

A: Excellent (minimum temperature was less than 110° C.)

B: Good (minimum temperature was equal to or greater than 110° C. and less than 120° C.)

C: Fair (minimum temperature was equal to or greater than 120° C. and less than 130° C.)

D: Poor (minimum temperature was equal to or greater than 130° C.)

From the results that were obtained, the “high temperature fixation” was determined by the following criteria.

A: Excellent (maximum temperature was equal to or greater than 195° C.)

B: Good (maximum temperature was equal to or greater than 185° C. and less than 195° C.)

C: Fair (maximum temperature was equal to or greater than 175° C. and less than 185° C.)

D: Poor (maximum temperature was less than 175° C.)

Method for Evaluating Heat Resistant Storage Property

Heat resistant storage stability was evaluated by whether or not an agglomerate was formed after high temperature storage. After 20 g of the external additive toner was hermetically sealed in a plastic container and was left to stand at 50° C. for 72 hours, the toner was removed and sifted with a 230 mesh sieve. The weight of the toner left on the sieve was measured, a residual amount that was a ratio of this weight to the total weight of the toner was determined and evaluations were performed by the following criteria. A lower residual amount indicates that the toner was prevented from being blocked and that the toner particles (toner matrix particles) were sufficiently coated with coating layers.

The criteria were as follows.

A: Excellent (no agglomeration, residual amount was less than 0.5%) B: Good (small amount of agglomeration, residual amount was equal to or greater than 0.5% and less than 7%)

C: Fair (large amount of agglomeration, residual amount was equal to or greater than 7% and less than 12%)

D: Poor (large amount of agglomeration, residual amount was equal to or greater than 12%)

Method for Comprehensive Evaluations

Based on the evaluation results described above (the low temperature fixation, the high temperature fixation and the heat resistant storage property), comprehensive evaluations were performed by the following criteria.

A: Excellent (A or B for all evaluation items, and among them, A for two or more evaluation items)

B: Good (A or B for all evaluation items, and among them, A for less than two evaluation items)

BC: Slightly good (C for one or more evaluation items without D)

C: Fair (D for any one of evaluation items but A for the other two evaluation items)

D: Poor (D for two or more evaluation items or D for any one of evaluation items but A or B for the other two items)

TABLE 6

| | Peak | | | | | | | | | | | | | |
|---|---|---|---|---|---|---|---|---|---|---|---|---|---|---|
| | temperature | | | SP value | | | | [symbol] | | | | | | |
| | (° C.) | | | | | | SP2 − | Ta | Tm | | Evaluation results | | | |
| | T1 | T2 | Tc | SP1 | SP2 | SP3 | SP1 | (° C.) | (° C.) | [symbol] | Low [symbol] | High [symbol] | [symbol] | [symbol] |
| Example 1 | 75 | 64 | 72 | 8.9 | 9.6 | 10.9 | 0.7 | 56 | 97 | 0.7 | A | B | A | A |
| Example 2 | 72 | 62 | 66 | 8.9 | 9.8 | 11.3 | 0.9 | 56 | 97 | 0.7 | A | B | B | B |
| Example 3 | 90 | 65 | 72 | 8.6 | 9.6 | 10.9 | 1.0 | 56 | 97 | 0.7 | B | B | A | B |
| Example 4 | 79 | 62 | 72 | 8.9 | 9.6 | 10.9 | 0.7 | 56 | 97 | 0.7 | A | A | B | A |
| Example 5 | 79 | 62 | 72 | 8.9 | 9.6 | 10.9 | 0.7 | 56 | 97 | 1.0 | A | A | C | BC |
| Example 6 | 75 | 64 | 65 | 8.9 | 9.8 | 11.3 | 0.9 | 56 | 97 | 0.7 | A | B | B | B |
| Example 7 | 72 | 62 | 67 | 8.9 | 10 | 10.9 | 1.1 | 56 | 97 | 0.7 | A | B | C | BC |
| Example 8 | 72 | 62 | 66 | 8.9 | 9.8 | 11.3 | 0.9 | 68 | 118 | 0.7 | B | B | A | B |
| Example 9 | 75 | 64 | 72 | 8.9 | 9.6 | 10.9 | 0.7 | 68 | 118 | 0.7 | B | B | A | B |
| Example 10 | 75 | 64 | 72 | 8.9 | 9.6 | 10.9 | 0.7 | 56 | 97 | 0.9 | A | A | C | BC |
| Example 11 | 75 | 64 | 72 | 8.9 | 9.6 | 10.9 | 0.7 | 56 | 97 | 0.7 | A | A | B | B |
| Example 12 | 75 | 64 | 72 | 8.9 | 9.6 | 10.9 | 0.7 | 56 | 97 | 0.2 | B | C | A | BC |
| Example 13 | 75 | 64 | 72 | 8.9 | 9.6 | 10.9 | 0.7 | 56 | 97 | 0.5 | C | B | A | BC |
| Example 14 | 75 | 64 | 72 | 8.9 | 9.6 | 10.9 | 0.7 | 56 | 97 | 0.6 | B | B | A | B |
| Example 15 | 75 | 64 | 72 | 8.9 | 9.6 | 10.9 | 0.7 | 56 | 97 | 0.8 | A | B | B | B |
| Example 16 | 75 | 64 | 72 | 8.9 | 9.6 | 10.9 | 0.7 | 56 | 97 | 0.9 | A | B | C | BC |
| Example 17 | 75 | 64 | 72 | 8.9 | 9.6 | 10.9 | 0.7 | 58 | 142 | 0.5 | C | B | A | BC |
| Example 18 | 75 | 64 | 72 | 8.9 | 9.6 | 10.9 | 0.7 | 58 | 142 | 0.6 | B | B | A | B |
| Example 19 | 75 | 64 | 72 | 8.9 | 9.6 | 10.9 | 0.7 | 56 | 142 | 0.7 | A | B | A | A |
| Example 20 | 75 | 64 | 72 | 8.9 | 9.6 | 10.9 | 0.7 | 58 | 142 | 0.8 | A | B | B | B |
| Example 21 | 75 | 64 | 72 | 8.9 | 9.6 | 10.9 | 0.7 | 58 | 142 | 0.9 | A | B | C | BC |
| Example 22 | 79 | 62 | 72 | 8.9 | 9.6 | 10.9 | 0.7 | 56 | 97 | 1.2 | A | A | D | C |
| Comparative | 65 | 61 | 72 | 8.6 | 9.6 | 10.9 | 1.0 | 56 | 97 | 0.7 | A | B | D | D |
| example 1 | | | | | | | | | | | | | | |
| Comparative | 79 | 62 | 60 | 8.9 | 9.5 | 10.9 | 0.6 | 56 | 97 | 0.7 | B | A | D | D |
| example 2 | | | | | | | | | | | | | | |
| Comparative | 75 | 64 | 72 | 8.9 | 9.6 | 10.9 | 0.7 | | | 0.9 | B | A | D | D |
| example 3 | | | | | | | | | | | | | | |
| Comparative | 65 | 61 | 66 | 8.8 | 9.6 | 10.9 | 0.8 | 56 | 97 | 0.7 | A | B | D | D |
| example 4 | | | | | | | | | | | | | | |
| Comparative | 55 | 61 | 65 | 8.8 | 9.6 | 10.9 | 0.8 | 68 | 118 | 0.7 | B | C | D | D |
| example 5 | | | | | | | | | | | | | | |
| Comparative | 85 | 65 | 72 | 8.6 | 9.6 | 10.9 | 1.0 | 56 | 97 | 0.7 | D | B | B | D |
| example 6 | | | | | | | | | | | | | | |
| Comparative | | | 72 | 8.9 | 9.6 | 10.9 | 0.7 | 56 | 97 | 0 | C | D | A | D |
| example 7 | | | | | | | | | | | | | | |

[symbol]

indicates data missing or illegible when filed

As is clear from table 6, the toners of examples 1 to 22 which included the amorphous polyester resin, the crystalline resin, the ester wax and the dispersant, in which the dispersant included the acrylic copolymer resin or the hybrid resin of the amorphous polyester resin and the styrene resin, in which T2<Tc<T1 was satisfied and in which T1 was greater than 65° C. and less than 85° C. were excellent in the comprehensive evaluations of the low temperature fixation, the high temperature fixation (hot offset resistance) and the heat resistant storage property.

By contrast, in comparative example 1 in which T2<T1<Tc was satisfied and in which T1 was equal to or less than 65° C., the evaluation of the heat resistant storage property was D, and thus comparative example 1 was inferior to the examples.

In comparative example 2 in which Tc<T2<T1 was satisfied, the evaluation of the heat resistant storage property was D, and thus comparative example 2 was also inferior to the examples.

In comparative example 3 in which the dispersant (the acrylic copolymer resin and the hybrid resin) was not included, the evaluation of the heat resistant storage property was D, and thus comparative example 3 was also inferior to the examples.

In comparative examples 4 and 5 in which T1 was equal to or less than 65° C., the evaluation of the heat resistant storage property was D, and thus comparative examples 4 and 5 were also inferior to the examples.

In comparative example 6 in which T1 was equal to or greater than 85° C., the evaluation of the low temperature fixation was D, and thus comparative example 6 was also inferior to the examples.

When examples 4, 5 and 22 in which the polyol ester wax (1) was used as the ester wax are considered, it is found that all the examples were excellent in the low temperature fixation and the high temperature fixation. It is found that among them, examples 4 and 5 in which the dispersion diameter of the wax was equal to or less than 1 μm were more excellent in the heat resistant storage property.

In the toner of comparative example 7 which did not contain the ester wax, the evaluation of the high temperature fixation was D, and thus comparative example 7 was inferior to the examples.

### OTHER EMBODIMENTS

The embodiment disclosed herein are illustrative in all respects, and does not constitute grounds for limited interpretation. Hence, the technical scope of the present invention is not interpreted only by the embodiment described above and is defined based on the scope of claims. The technical scope of the present invention includes meanings equivalent to the scope of claims and all modifications within the scope.

What is claimed is:

1. A toner comprising toner particles that include a binding resin, a crystalline resin, an ester wax and a dispersant,
wherein the binding resin includes an amorphous polyester resin,
the dispersant includes an acrylic copolymer resin or a hybrid resin of the amorphous polyester resin and a styrene resin and
when an endothermic peak temperature that is derived from the ester wax in a temperature rise is represented by T1, an exothermic peak temperature that is derived from the ester wax in cooling is represented by T2, a peak temperature of the crystalline resin is represented by Tc, and the endothermic peak temperature, the exothermic peak temperature and the peak temperature are measured with a differential scanning calorimeter, T2<Tc<T1 is satisfied, and T1 is greater than 65° C. and less than 85° C.

2. The toner according to claim 1,
wherein the ester wax includes a polyol ester wax, and
a dispersion diameter of the ester wax in the toner particles is equal to or less than 1 μm.

3. The toner according to claim 1,
wherein when an SP value of the ester wax is represented by SP1, an SP value of the crystalline resin is represented by SP2 and an SP value of the amorphous polyester resin is represented by SP3, SP1<SP2<SP3 is satisfied, and SP2−SP1≤1 is satisfied.

4. The toner according to claim 1,
wherein when the endothermic peak temperature that is derived from the ester wax in the temperature rise is represented by T1, a glass transition temperature of the dispersant is represented by Ta, and the endothermic peak temperature and the glass transition temperature are measured with the differential scanning calorimeter, Ta<T1 is satisfied.

5. The toner according to claim 1,
wherein a content of the ester wax in the toner particles is equal to or greater than 0.5% by mass and equal to or less than 5.0% by mass.

6. The toner according to claim 1,
wherein a softening temperature of the acrylic copolymer resin measured with a flow tester is equal to or greater than 95° C. and equal to or less than 119° C.

7. The toner according to claim 1,
wherein a content of the acrylic copolymer resin in the toner particles is equal to or greater than 1.0% by mass and equal to or less than 5.0% by mass.

8. The toner according to claim 1,
wherein a content of the hybrid resin in the toner particles is equal to or greater than 7.0% by mass and equal to or less than 32.0% by mass.
